(19) United States
(12) Patent Application Publication
(10) Pub. No.: US 2013/0000851 A1
(43) Pub. Date: Jan. 3, 2013

(54) Automatic Backing Stripper

(75) Inventor: Michael Gerard Wohletz, Lee's Summit, KS (US)

(73) Assignee: AUTOMATIC SYSTEMS, INC., Kansas City, MO (US)

(21) Appl. No.: 13/533,687

(22) Filed: Jun. 26, 2012

Related U.S. Application Data
(60) Provisional application No. 61/503,207, filed on Jun. 30, 2011.

(51) Int. Cl. B29C 73/26

(52) U.S. Cl. 156/702; 156/751

(57) ABSTRACT

Fiberglass batts are installed between the side-by-side studs in the interior walls of a home or building to insulate the walls and minimize sound transfer. Each fiberglass batt has a paper backing that projects from the side edges of the batt to provide for attachment to the spaced, side-by-side wall studs that comprise the internal frame to which the walls are secured. However, a significant percentage of the backing is produced with a noncompliant, reduced width and thus those batts are discarded. In the present invention a stripper mechanism between an input conveyor that receives the inferior batts and an output conveyor strips the backing therefrom so that the fiberglass may be used in other applications.

### CROSS REFERENCE TO RELATED APPLICATION

This application claims the benefit of a prior filed, co-pending provisional application Ser. No. 61/503,207, filed Jun. 30, 2011.

### FIELD OF THE INVENTION

This invention relates to an automated method and apparatus for separating a material from a backing on the material and, more specifically, to an automated method and apparatus for separating fiberglass from a paper backing.

### BACKGROUND OF THE INVENTION

Strips of fiberglass material are commonly used in construction to provide insulation and sound proofing, particularly in the walls, floors and ceilings of residential and commercial structures. Typically, the fiberglass is in the form of an elongated, rectangular batt that extends in walls, for example, from floor to ceiling and is secured on spaced vertical supporting members or studs that define the internal structure of the wall. A paper backing extends laterally from one face of the fiberglass batt upon which it is applied, thereby providing opposed, exposed backing strips for securing the insulation to the studs, such as 2×4 lumber.

However, a minor percentage of the paper-backed fiberglass batts are defective for construction purposes because of errors in production that result in fiberglass backed with paper that is too narrow to provide a sufficient means of attachment to the studs. Accordingly, in fiberglass manufacturing some of the end product fails to meet quality requirements. Currently the non-conforming product is segregated and dealt with manually by peeling the fiberglass off of the paper, discarding the paper and then recycling the fiberglass through a grinder so it may be blown into another product. This occurs with sufficient regularity that manufacturers currently incur the cost of employing additional personnel for the purpose of separating the fiberglass from the defective backing and then recycling the material.

### SUMMARY OF THE INVENTION

In one aspect of the present invention, the aforementioned problem of increased manufacturing cost is addressed by providing an automated stripper apparatus having input and output belt conveyors, and a stripper mechanism therebetween that compresses the fiberglass on defective batts and then separates the paper backing from the fiberglass material. The compression facilitates separation and presses the fiberglass/paper onto a spiked roller which pulls the paper away from the fiberglass. The paper is then discharged downwardly by the action of the spiked roller while the fiberglass advances onto an outgoing belt conveyor which delivers the backing-free fiberglass material. The defective paper, now separated from the fiberglass, exits beneath the conveyor and is discarded at the end of the process. A significant percentage of the fiberglass is thus automatically salvaged with minimal man power and may then be recycled and subsequently utilized.

In another aspect of the present invention, the input conveyor receives successive batts of material, such as insulating material having a backing thereon, in a continuous process and advances the batts in a predetermined direction of travel to an output conveyor. A stripper mechanism between the input and output conveyors removes the backing from the batts as they advance, and utilizes a transverse roller in a gap between the input and output conveyors. The transverse roller is provided with spikes that engage, remove and discharge the insulating material, thereby delivering batts that are backing-free to an output conveyor.

In another aspect of the present invention the input conveyor receives successive batts of the paper backed insulating material having defective backing in a continuous process and advances the batts in a predetermined direction of travel to the output conveyor. A stripper mechanism between the input and output conveyors removes the backing from the batts as they advance, and utilizes a transverse roller disposed in a gap between the input and output conveyors. The transverse roller is provided with spikes that engage, remove and discharge the paper backing, thereby delivering batts that are backing-free to an output conveyor.

In yet another aspect of the present invention, a delivery table is provided for receiving the backing-free batts.

In a further aspect of the present invention, the transverse roller from which the plurality of spikes project and are arranged thereon to extend generally radially outwardly from the roller for engaging the backing to separate the paper therefrom and then deliver the batts, now free of the backing, to the output conveyor.

Other advantages of this invention will become apparent from the following description taken in connection with the accompanying drawings, wherein is set forth by way of illustration and example, an embodiment of the present invention.

### BRIEF DESCRIPTION OF THE DRAWINGS

FIG. 1 is a plan view of a two stage stripper apparatus for receiving defective batts of insulation material and discharging each batt free of its paper backing

FIG. 2 is a side elevational view the stripper apparatus of FIG. 1, which would typically be supported horizontally above an underlying floor (not shown) for convenient delivery of defective fiberglass batts thereto at the left end as illustrated and discharge of backing-free fiberglass material at the right end thereof.

FIG. 3 is a partial, cross-sectional view looking in the direction defined by arrows 3-3 in FIG. 2, which is the direction of travel of the material.

FIG. 4 is a cross-sectional view looking in the direction defined by arrows 4-4 in FIG. 2, which is the direction of travel of the material.

FIG. 5 is a diagrammatic side view of the conveyor components of the apparatus.

FIG. 6 is an enlarged end elevation of the apparatus as seen from the left or input end of FIG. 2 with parts removed to show the transverse spiked roller.

FIG. 7 is a fragmentary side elevation showing conveyor drive components taken along line 7-7 in FIG. 1.

FIG. 8 is a top plan view similar to FIG. 1 showing insulation entering the apparatus from the left end.

FIG. 9 is a cross-sectional side view taken along line 9-9 in FIG. 8 showing, in elevation, entry of a batt of insulation into the stripper apparatus.

FIG. 10 is a plan view similar to FIG. 8 showing further advancement of the insulation.

FIG. 11 is a cross-sectional view along line 11-11 in FIG. 10 showing the insulation delivered into the stripper and compressed to cause the paper backing of the insulation to be punctured by spikes in a transverse roller.

FIG. 12 is a plan view similar to FIG. 10 showing still further advancement of the insulation.

FIG. 13 is a cross-sectional view taken along line 13-13 in FIG. 12 and looking in the direction of the arrows, illustrating separation of the paper from the insulation and showing the paper exiting from beneath the conveyor while the insulation is further advanced.

FIG. 14 is a perspective view of the apparatus from above showing insulation at the output (on the left) separated from the paper backing by the spiked roller.

FIG. 15 is a perspective view similar to FIG. 14 from the opposite side.

FIG. 16 is an enlarged view of the mid-portion of the stripper apparatus as seen in FIG. 11 showing the spiked roller and associated components in greater detail.

FIG. 17 is an enlarged view of the roller component showing the spikes spaced therealong.

FIG. 18 is an enlarged, cross-sectional view of the roller along line 18-18 of FIG. 17 showing the spikes spaced around the roller and projecting radially outwardly therefrom.

FIG. 19 is a perspective view from above showing a demonstration stripper table wherein paper backing is separated from a non-conforming insulating product by the action of the components illustrated in FIG. 13.

FIG. 20 is a perspective view showing further advancement of the stripped product and discharge of the backing onto the floor beneath the stripper.

FIG. 21 shows a piece of the usable fiberglass material on the left and the backing separated therefrom on the right at the completion of the stripping process.

### DETAILED DESCRIPTION

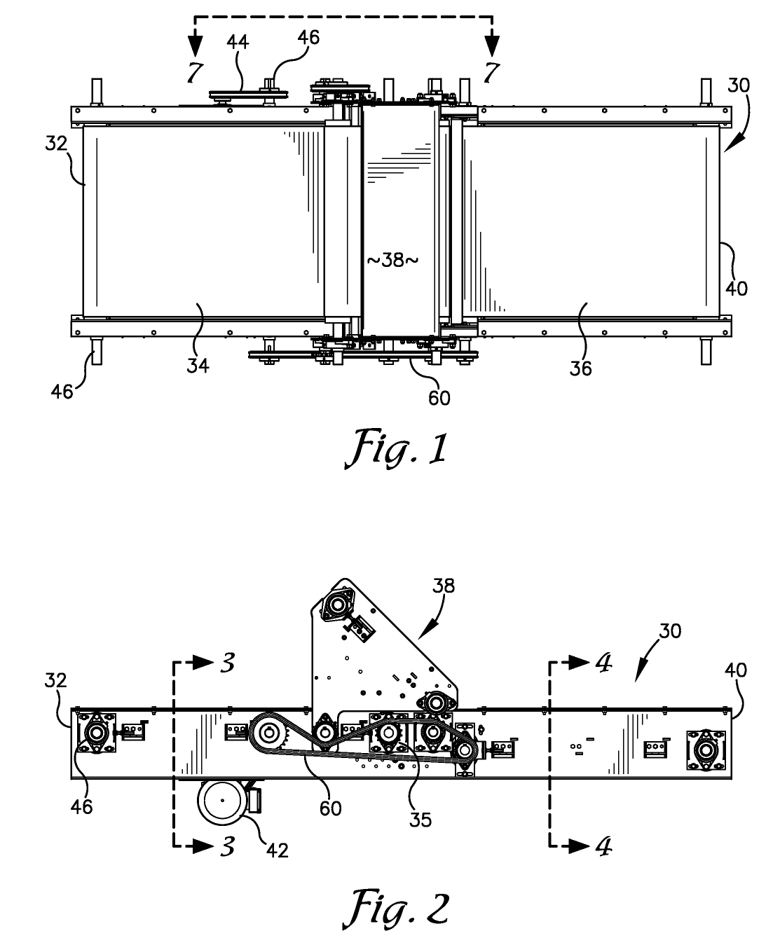

Referring to the drawings, FIGS. 1 and 2 are plan and side elevational views respectively of the automatic backing stripper of the present invention, which removes defective paper backing from a fiberglass batt thereby separating the two components in an entirely automated process. The backing may be defective for a number of reasons. In particular as mentioned above the width of the backing may be insufficient to provide a projecting strip along each side of a batt to permit proper attachment to, for example, spaced, side-by-side studs that comprise the internal frame of an interior wall of a home or building. As will be set forth more fully hereinbelow, in the present invention the result is that the separated fiberglass may be fragmented and then used as bulk insulation, and the defective backing strip discarded. It should be understood that dimensions shown on the drawings are exemplary only.

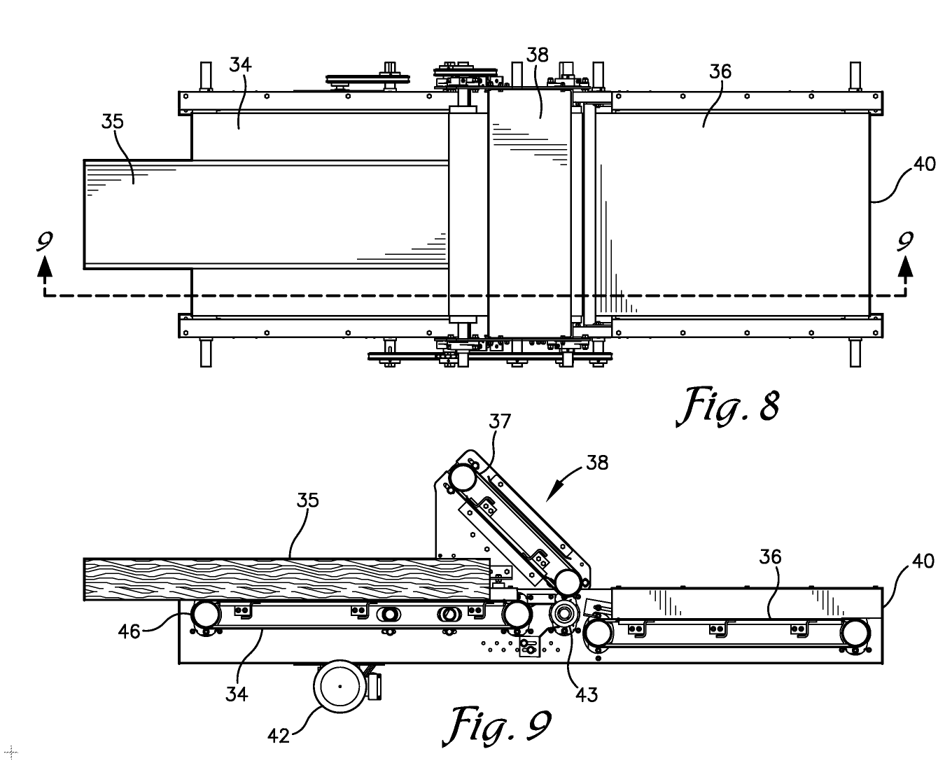

The automatic backing stripper 30 (see FIG. 1) has a receiving end 32 at which an input belt conveyor 34 receives successive panels of defective insulating material each having a two-component fiberglass batt 35 comprising the relatively thick fiberglass batt material and the thin, defective paper backing 35a (see FIGS. 8 and 9). An output belt conveyor 36 disposed in series with and below the input conveyor receives the panel with the backing removed therefrom. A stripper mechanism 38 between the input and output conveyors is provided with means described more fully hereinafter for engaging the panels and removing the backing from the fiberglass. Stripped of the backing, the output belt conveyor 36 in series with the input conveyor 34 advances each backing-free panel from the stripper mechanism to an output end 40 of the apparatus thereby providing backing-free material at the output end ready for use in insulation applications as desired.

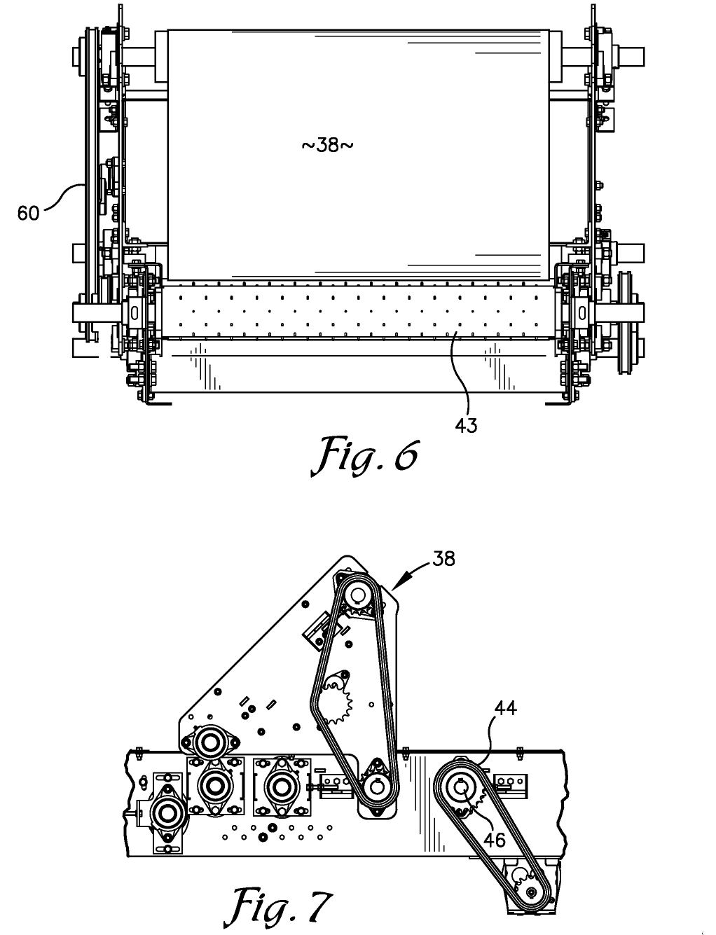

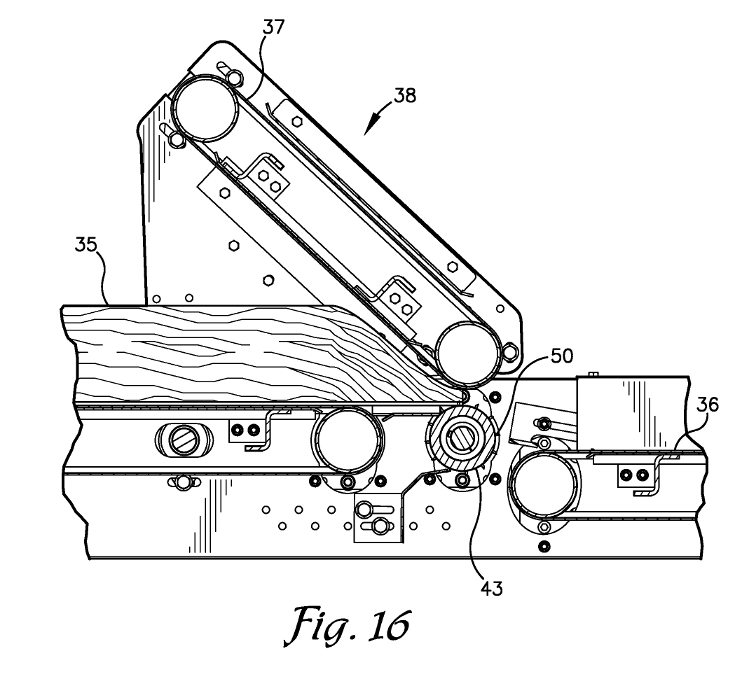

FIGS. 1, 2 and 5 in particular show an embodiment of the present invention in a plan view, side elevational view and a diagrammatic side view respectively. The cooperative action of the active components of the apparatus is illustrated in the diagram of FIG. 6 which is a vertical cross-section along line 6-6 in FIG. 5. Clearly, the endless receiving belt 34 extends from the receiving end 32 to the middle of the conveyor, and the endless delivery belt 36 extends therefrom to the output end 40. The paper-backed fiberglass batts are thus successively fed from the receiving end 32 to the stripper mechanism 38 where the backing is removed, and then advanced to the output end 40. The cover over mechanism 38 is removed in FIGS. 9, 11 and 13-16 to reveal the mechanism in detail.

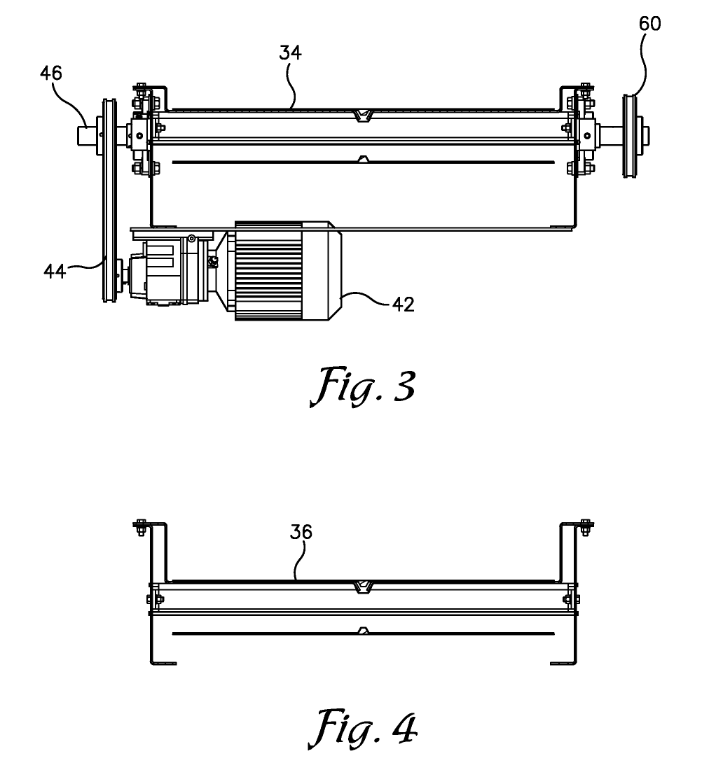

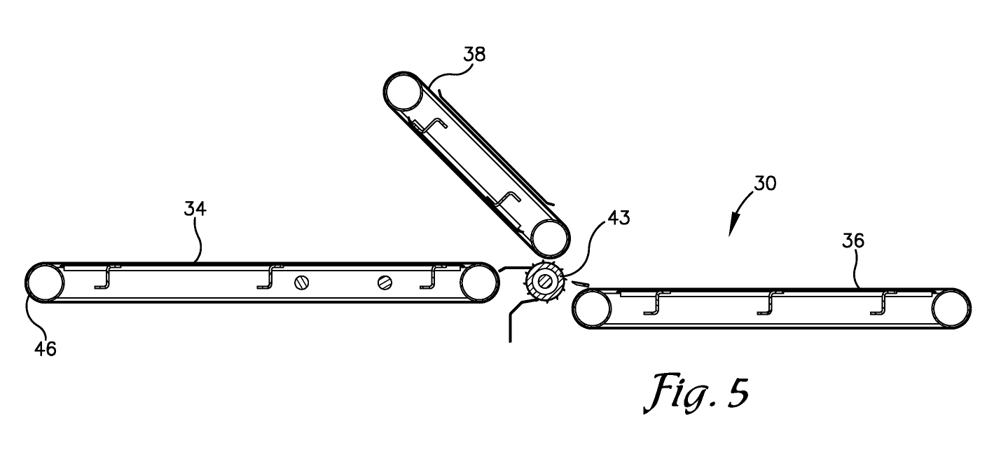

FIG. 3 is a cross-sectional view at 3-3 in FIG. 2 looking in the direction of travel of the fiberglass batts and showing drive components including a motor 42 coupled by a belt and pulley drive 44 to a horizontal, transversely extending shaft 46 at the receiving end of the belt 34. The upper run of the receiving belt 34 is thus driven from left to right as viewed in FIGS. 1 and 2. This feeds incoming defective batts (discussed more fully hereinbelow) to the stripper mechanism 38 shown in detail in the enlarged views of FIGS. 9, 11 and 13 which show the input belt 34, a stripper belt 37 and the output or delivery belt 36. A transverse roller 43 (FIGS. 11 and 13) is specially equipped and arranged as discussed below to cause the paper backing 35a on the fiberglass strips to wrap around roller 43 thus separating the paper from the insulation where it then exits beneath roller 43 and is discarded. The insulation, now free of the paper backing, continues to advance to the right as seen in FIG. 13 on to belt 36 from which it is ultimately discharged at the right end thereof.

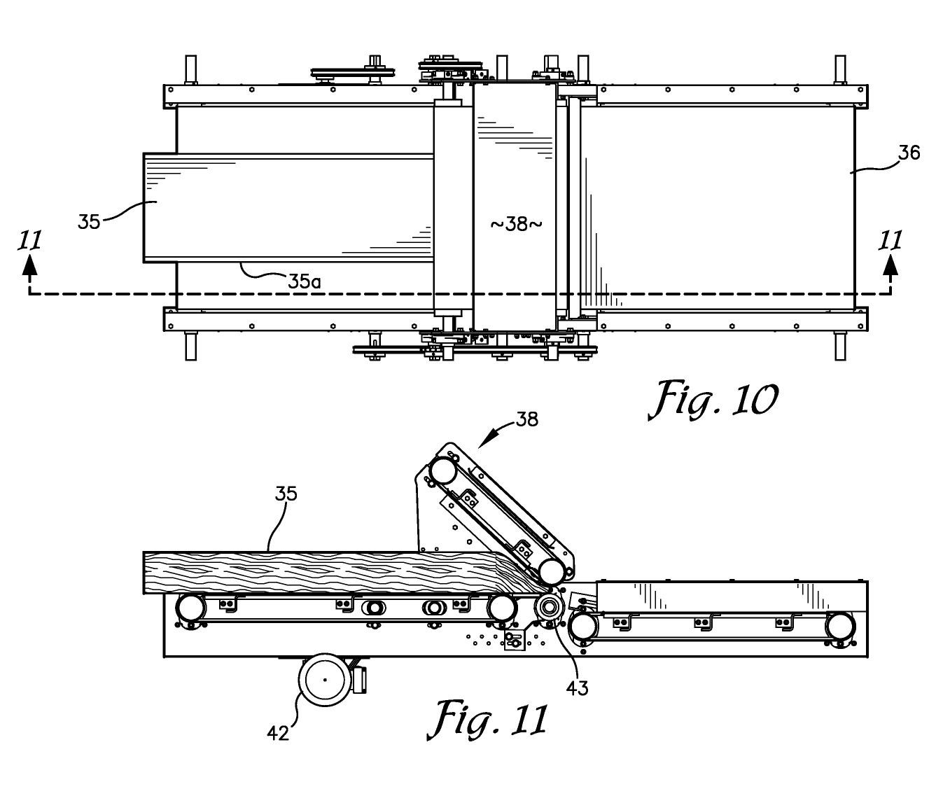

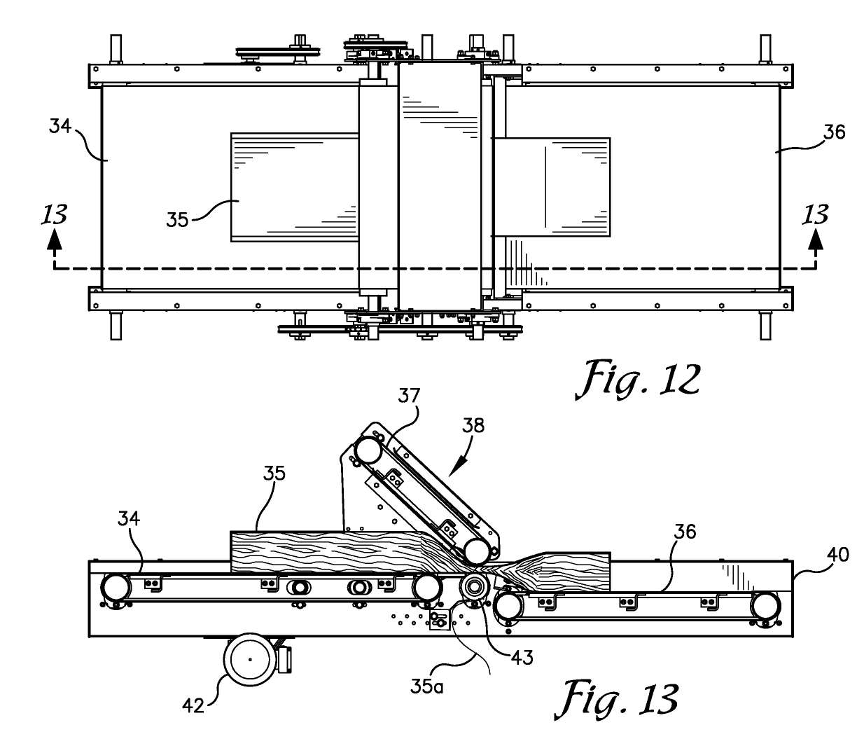

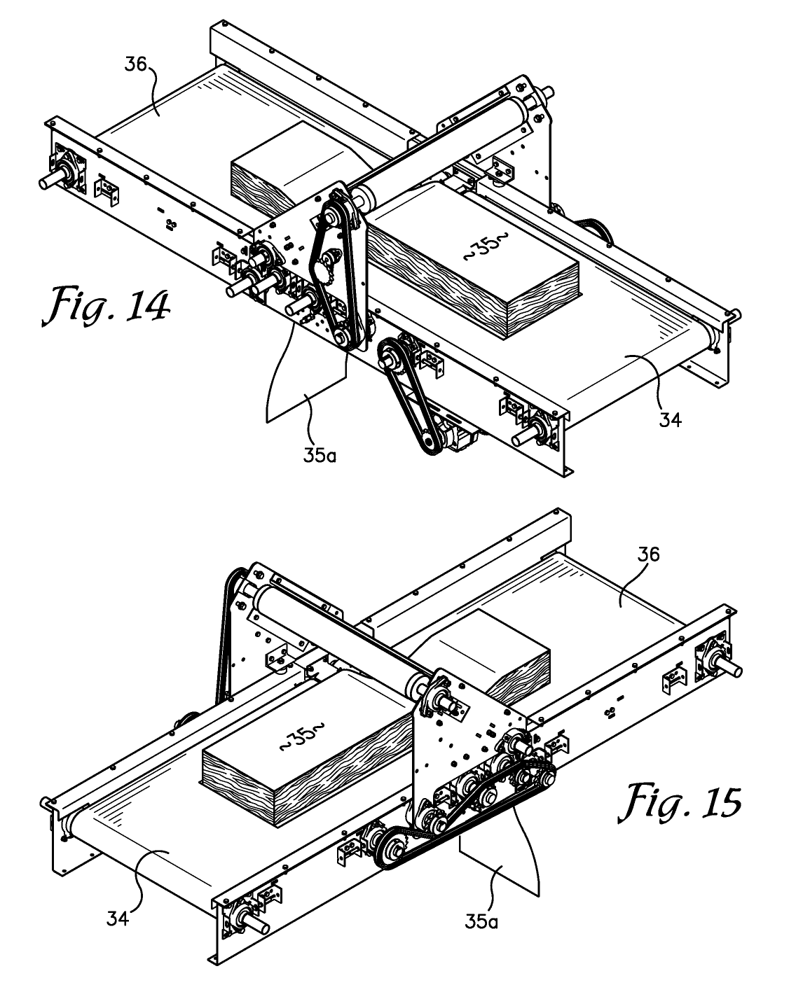

The sequence just described above is also illustrated in the top plan views of FIGS. 8, 10 and 12 corresponding essentially to FIGS. 9, 11 and 13 respectively. Similarly, FIGS. 14 and 15 show the apparatus in perspective views from above from each side of the complete apparatus and correspond to the cross-sectional view of FIG. 13.

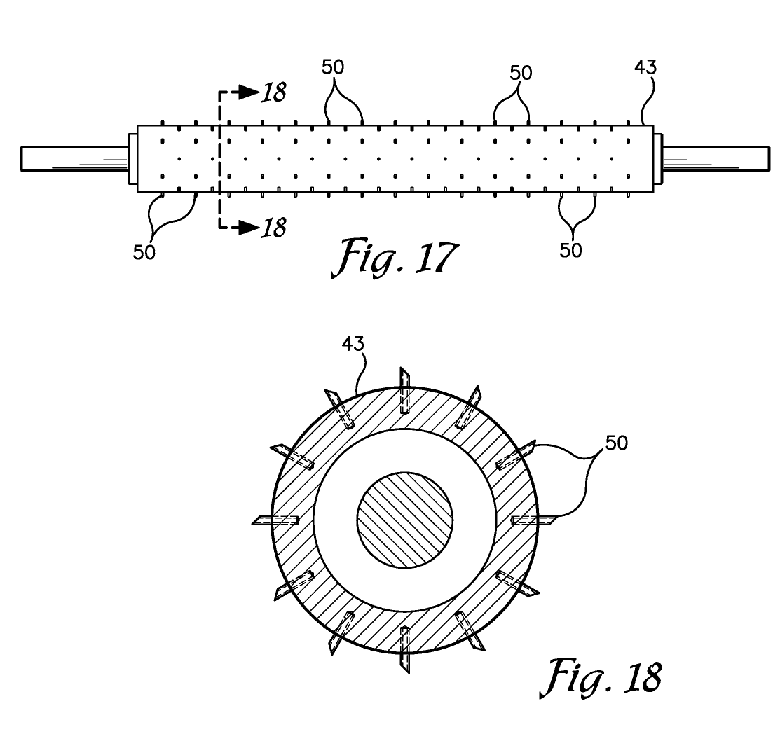

The diagrammatic side view of FIG. 5 is particularly illustrative in showing the operation of the two-stage automatic backing stripper 30. The receiving belt 34 extends generally in a plane somewhat above that of the delivery belt 36, and the overhead belt 38 extends downwardly and forwardly at an angle and terminates just above the space or gap between belts 34 and 36. Its function is to press the incoming fiberglass batts downwardly at the gap and into a number of radial spikes projecting from the outer surface of roller 43 which is essentially centered in the gap between the delivery end of the receiving conveyor 34 and the input end of the output conveyor 36. More specifically as clearly shown in FIGS. 17 and 18, roller 43 has a number of spikes 50 projecting therefrom along its entire length (which extends the entire width of the conveyor) and comprises a series of twenty-nine circular rows of spikes 50 (FIG. 17) in the illustrated embodiment, with twelve equally spaced spikes in each row as shown in FIG. 18. A sprocket and belt drive 60 to roller 43 (FIGS. 2 and 18) causes the paper, punctured by the pins in roller 43 to wrap partially around the roller and thus separates the paper from the insulation and discharges the paper beneath the apparatus.

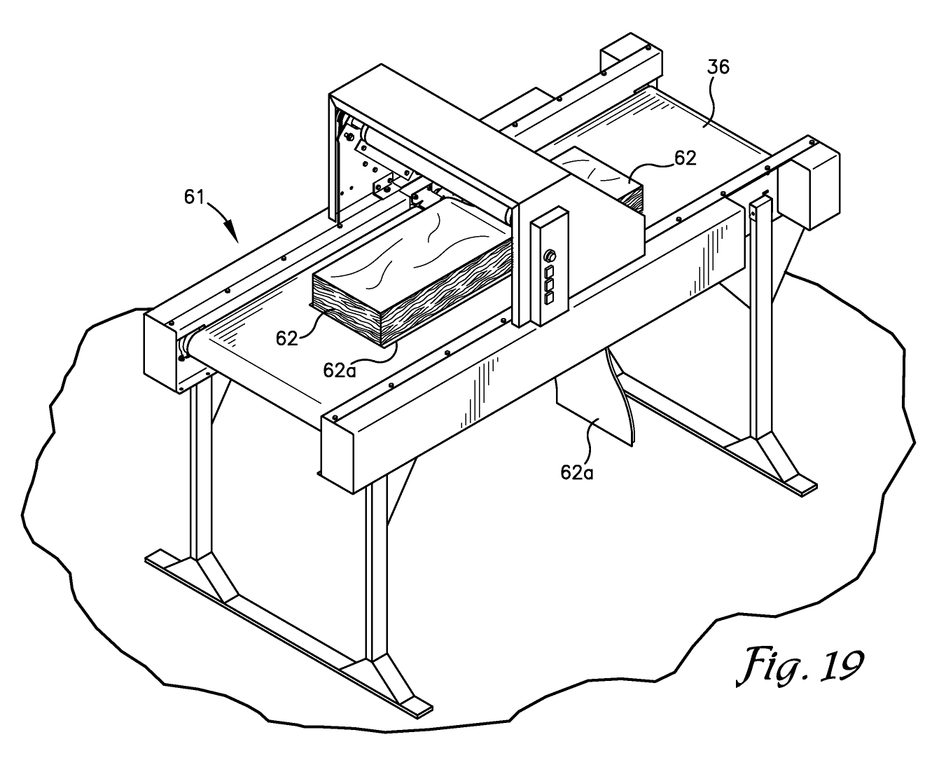

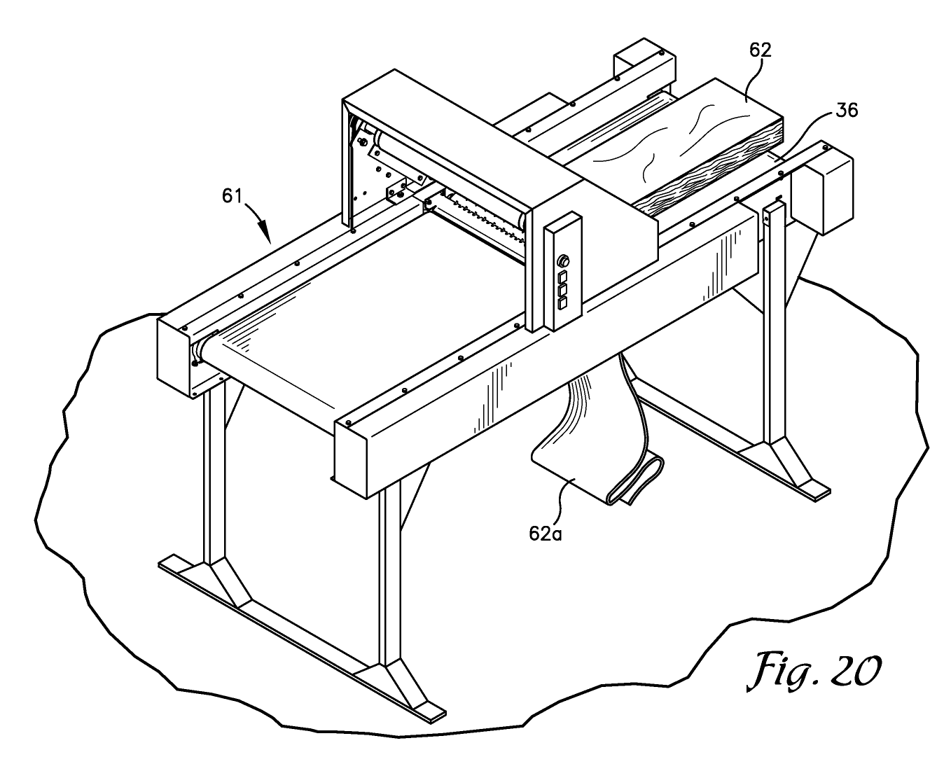

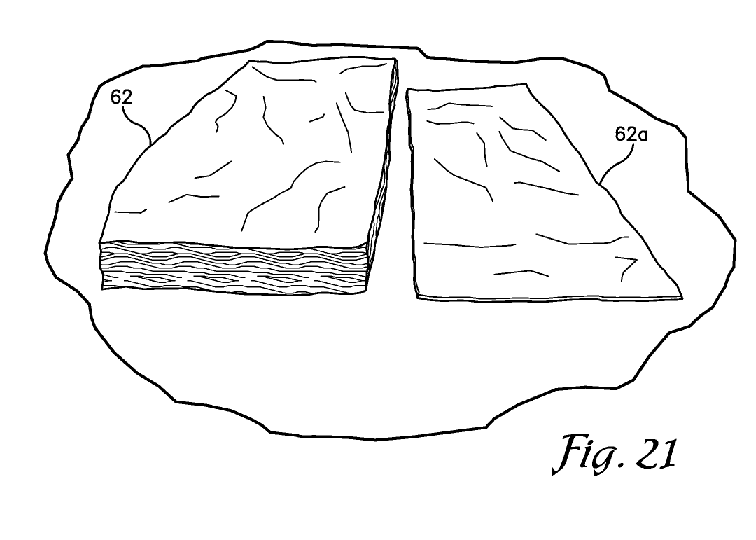

FIGS. 19 and 20 show a demonstration table 61 employing the automatic backing stripper of the present invention where, in FIG. 19, a fiberglass batt 62 with defective backing 62a thereon is shown on the left entering the compression mechanism and, on the right, exiting therefrom with the stripped backing material 62a discharging therebeneath. FIG. 20 shows nearly complete progression of the batt 62 therethrough and a long strip of discharged waste backing 62a accumulating beneath the table. FIG. 21 shows a comparison of the separated products, a backing-free batt of insulation 62 on the left and the thin, defective stripped backing 62a on the right. The fiberglass panel on the left, freed of its backing, may then be recycled and subsequently utilized such as, for example, as bulk insulation.

In summary, in the present invention a method and an apparatus are provided for automatically separating insulating material from a backing applied to the material. An input belt conveyor receives a panel of the insulating material with backing thereon, and an output belt conveyor receives the panel with the backing removed therefrom. A stripper mechanism between the input and output conveyors is provided with a spiked roller for engaging the panel and removing the backing. The output belt conveyor advances the backing-free panel from the stripper mechanism to an output end of the apparatus where it is collected and ready for use in applications as desired.

Having thus described the invention, what is claimed as new and desired to be secured by Letters Patent is:

1. Apparatus for separating a backing from a batt of material comprising:
an input conveyor for receiving successive batts of material each having a backing thereon and advancing the batts in a predetermined direction of travel,
an output conveyor spaced from said input conveyor for receiving said batts therefrom, and
a stripper mechanism between said input and output conveyors for removing said backing from the batts as they advance, said mechanism including a roller extending transversely with respect to said direction of travel and engaging the batts to separate the backing therefrom for delivery of backing-free batts to said output conveyor, whereby batts delivered to the output conveyor have the backing stripped therefrom.

2. The apparatus as claimed in claim 1, wherein said apparatus includes a delivery table for receiving the backing-free batts.

3. The apparatus as claimed in claim 1, wherein said input and output conveyors define a transverse gap therebetween, said roller being disposed in said gap to compress the batts and cause the separated backing to exit beneath the apparatus.

4. The apparatus as claimed in claim 1, wherein said roller is provided with a plurality of spikes extending generally radially outwardly therefrom for engaging the backing to separate the paper therefrom and then deliver the batts to the output conveyor with the backing removed therefrom.

5. Apparatus for stripping a backing from a batt of fiberglass material comprising:
an input conveyor for receiving successive batts of fiberglass material each having a paper backing on one face thereof and advancing the batts in a predetermined direction of travel,
an output conveyor spaced from said input conveyor for receiving said batts therefrom, and
a stripper mechanism between said input and output conveyors for removing said paper backing from the batts as they advance, said mechanism including a roller extending transversely with respect to said direction of travel and provided with generally radially, outwardly projecting spikes for engaging the batts as they advance over the roller to thereby separate the backing therefrom for delivery of backing-free batts to said output conveyor, whereby batts delivered to the output conveyor have the backing stripped therefrom.

6. The apparatus as claimed in claim 5, wherein said apparatus includes a delivery table for receiving the backing-free batts.

7. The apparatus as claimed in claim 5, wherein said input and output conveyors define a transverse gap therebetween, said roller being disposed in said gap to compress the batts and cause the separated backing to exit beneath the apparatus.

8. The apparatus as claimed in claim 5, wherein said roller is provided with a plurality of spikes extending generally radially outwardly therefrom for engaging the backing to separate the paper therefrom and then deliver the batts to the output conveyor with the backing removed therefrom.

9. Apparatus for separating insulating material from a backing applied to the material, said apparatus comprising:
an input belt conveyor for receiving a panel of the insulating material having said backing thereon, and an output belt conveyor for receiving said panel withh the backing removed therefrom, and
a stripper mechanism between said input and output conveyors provided with means for engaging said panel and removing the backing therefrom as the panel advances,
said output conveyor advancing the backing-free panel from the stripper mechanism to an output end of the apparatus, whereby to automatically remove the backing and present backing-free material at said output end.

10. A method of separating a backing from a batt of material comprising:
providing an input conveyor for receiving successive batts of material and advancing each batt in a predetermined direction, each of said batts having a backing thereon which extends laterally with respect to said direction and projects beyond opposed edges of the batt,
providing an output conveyor spaced from said input conveyor for receiving said batts therefrom, and
continuously successively stripping the backing from said batts as each batt is advanced in succession in said direction by the input conveyor to the output conveyor, whereby batts delivered to the output conveyor are backing-free.

11. The method as claimed in claim 10, further comprising providing a roller in the space between the input and output conveyors having radially extending spikes for engaging and stripping the backing from the batts.
